(19) United States
(12) Patent Application Publication
(10) Pub. No.: US 2009/0190031 A1
(43) Pub. Date: Jul. 30, 2009

(54) TELEVISION APPARATUS AND METHOD FOR SUBTITLE HANDLING

(76) Inventor: Herve Guihot, Palo Alto, CA (US)

Correspondence Address: NORTH AMERICA INTELLECTUAL PROPERTY CORPORATION, P.O. BOX 506, MERRIFIELD, VA, 22116, US

(21) Appl. No.: 12/020,581

(22) Filed: Jan. 28, 2008

(51) Int. Cl. H04N 7/00

(52) U.S. Cl. 348/468; 348/E07.033

(57) ABSTRACT

A string matching pattern is detected in a subtitle text stream extracted from a television stream. If there is a matched string covered by the string matching pattern in the subtitle text stream, a predetermined response is activated. For example, if the string matching pattern is a phone number syntax and there is a sequence number matching the phone number syntax, the response may be set as calling a phone according to the sequence number. Usually, subtitles only last for a few seconds, but the matched string may stay on a screen longer so that a user can have sufficient time to write it down.

### BACKGROUND OF THE INVENTION

1. Field of the Invention

The present invention relates to video processing, and more particularly relates to a television apparatus and method of processing subtitle information.

2. Background

With evolving techniques in video broadcasting methods, the transmission of audio-video signals has broadened to include supplementary and additional data to increase viewer options and improve overall viewing pleasure. Supplementary data can include features such as additional video angles, parental control signals, additional audio signals, and subtitle signals.

Subtitles are a textual display of dialogue found in film and television to help viewers understand and follow the audio dialogue of a program. Several TV, DTV, DVD, and satellite broadcasts additionally include a subtitle stream, separated from video streams or integrated in video images, to compliment the primary audio-visual data stream. The subtitle stream contains subtitle captions to be displayed synchronously onto the screen with the spoken dialogue. For example, a music video may have subtitles that show the lyrics of the song synchronized with the timing of the music video. Subtitles in a movie would simply display the spoken text of each person while they talk on screen.

Occasionally, subtitles may display some strings, i.e. sequences of characters, containing certain useful information, e.g. an e-mail address, a universal resource locator, a name or a telephone number, and users may want to write them down or use these strings for performing certain tasks, connecting to a website or dialing a phone number. But when such strings appear in subtitle text suddenly and unexpectedly, it is difficult and inconvenient for a user to write them down before such strings disappear from the screen.

### SUMMARY OF THE INVENTION

A preferred embodiment according to the invention is a television apparatus for playing a television stream. The television apparatus includes a storage, a parser, a player and a reactor. The storage, e.g. registers, memory devices, hard disks, etc., is used for storing a string matching pattern, which defines what type of strings to search for. The parser is used for extracting a video stream and a subtitle text stream from the television stream. The player is used for playing the video stream. The reactor detects whether the subtitle text stream contains one or more than one matched strings covered by the string matching pattern. If a matched string is found, the reactor activates a response according to the matched string.

An example of the string matching pattern is e-mail syntax. When an e-mail address is detected in a subtitle text stream while the string matching pattern is e-mail syntax, the reactor may automatically prepare an e-mail with its receiver field being set as the e-mail address. Another example is a phone number and the response what the reactor activates is to dial the phone number or keep the phone number appeared on a screen even other subtitle text adjacent to the phone number are no longer appeared on the screen.

In another aspect of the invention, a method is disclosed for handling subtitle information. The method may be implemented as corresponding programs running on a platform of an electronic system. With the invention, there are various interesting applications on subtitle information that may be developed to enhance user experience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a preferred embodiment of a television apparatus;

FIG. 2 is an exemplary implementation of the preferred embodiment;

FIG. 3 is a flowchart illustrating a method as another aspect of the preferred embodiment; and

FIG. 4 is example of screen output for applying the preferred embodiment.

### DETAILED DESCRIPTION

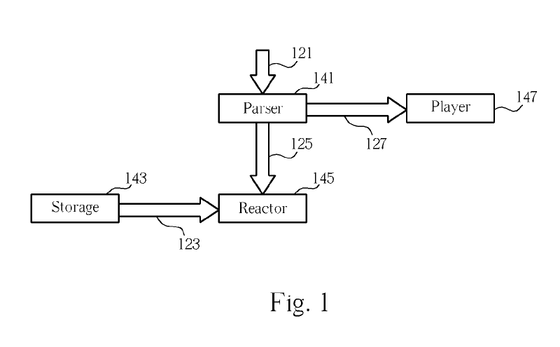

FIG. 1 illustrates a preferred embodiment which is a television apparatus for playing a television stream 121. For processing the television stream 121, the television apparatus includes a parser 141, a storage 143, a reactor 145 and a player 147. The storage 143, e.g. a memory device, stores a string matching pattern 123. The parser 141 extracts a video stream 127 and a subtitle text stream 125 from the television stream 121. The player 147 plays the video stream 127. The reactor 145 detects whether the subtitle text stream 125 contains one or more matched strings covered by the string matching pattern 123. If the matched string is detected, the reactor 145 activates a response according to the matched string.

There are various types of responses that may be set and configured by a user or preconfigured by manufacturers of the television apparatus. For example, if the matched string is a telephone number, the response may be configured as calling a phone with the telephone number if the reactor 145 is connected to a telephone network. Alternatively, the response may also be configured to keep showing the telephone number on a screen for a certain period, e.g. 30 seconds. In another example, the matched string is an e-mail and the response may be preparing an e-mail and setting a receiver address of the e-mail according to the matched string.

There are various ways to implement the above mentioned components. For, example, the parser 141, the storage 143, the reactor 145 and the player 147 each may be implemented with one or more than one circuit components and/or related program codes. Moreover, two or more than two of the components may be merged into a module. For example, the parser 141, the reactor 145 and the player 147 may each be implemented as a set of program codes running on a same set of hardware circuits.

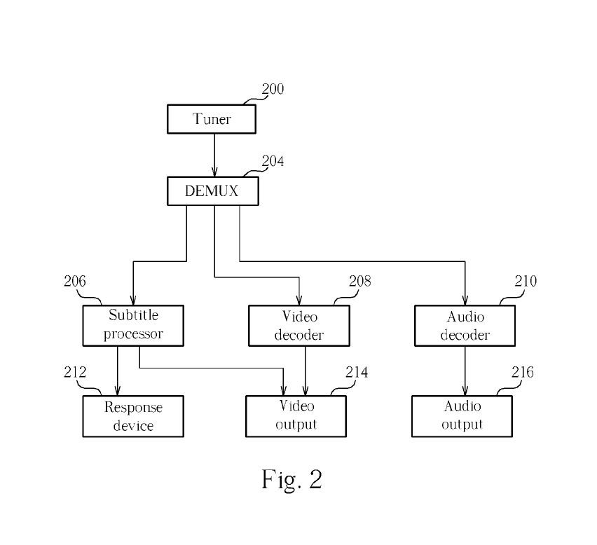

FIG. 2 illustrates an exemplary design of the preferred embodiment. In the exemplary design, a television stream is received from a tuner 200. The television stream may contain a video streams, an audio streams, and a subtitle text streams. The demultiplexer (DEMUX) 204 extracts the video stream, the audio stream and the subtitle text stream and then transmit these streams into a video decoder 208, an audio decoder 210 and a subtitle processor 206, respectively. A video output 214, e.g. a panel and related components, receives decoded video contents and plays the decoded video contents. Besides, an audio output 216, e.g. a speaker and associated components, receives decoded audio contents and plays the decoded audio contents.

In some television stream formats, subtitle information is carried in a separate subtitle text stream. In some other television stream formats, subtitle information is of the form of image, which has been or has not been mixed with the video stream. In such case, the subtitle information can be extracted by certain technology like OCR (optical character recognition). After OCR processing, a corresponding subtitle text stream is generated by the DEMUX 204 and supplied to the subtitle processor 206. Of course, in actual design, there are many variations to dispatch tasks to be handled by each component, e.g. the subtitle processor handling the OCR processing.

The subtitle processor 206, which may be composed of a series of program codes and/or associated hardware, may also supply desired subtitle images to be mixed into the decoded video contents in the video output 214. In addition, the subtitle processor 206 may parse the subtitle text stream to detect whether in the subtitle text stream, there is a matched string that is covered by a predetermined string matching pattern.

The string matching pattern may be defined by a regular expression or any other string searching conditions. For example, an e-mail address may be defined by an e-mail syntax, like “.+@.+\\.[a−z]+” in regular expression form. The e-mail syntax, therefore, can be used as a string matching pattern for indicating what type of strings is looking for. Besides, the string matching pattern may also be a string to be matched directly or several strings combined under certain Boolean operation. In addition, the string matching pattern may include multiple related conditions in addition to a string searching condition. For example, the string matching pattern may indicate finding a phone number only if the current channel is a shopping channel.

In the exemplary design of FIG. 2, the matched string is transmitted to a response device 212, which is a part of the reactor as mentioned in the preferred embodiment. If the response device 212 is coupled to a network and the matched string is a resource locator that indicates a resource object over a network, the response device 212 may access the resource object identified, e.g. a webpage, a video clip or a VoIP service, over the network.

The response device 212 may also be configured to provide an image related to the matched string to be mixed with the subtitle information supplied from the subtitle processor 206 and decoded video contents from the video decoder 208. For example, subtitle text adjacent to the matched string may stay on a screen for only 2 seconds, but the matched string may be displayed longer in a corner of the screen so that a user may have sufficient time to write down the matched string, even the adjacent text is no more appearing on the screen. The response device 212 may also issue an instruction back to the subtitle processor 206 so as to highlight the matched string when the matched string is displayed with adjacent subtitle text. The response device 212 may also store the matched string in a storage device so that the matched string can be used later. If the matched string is stored, the response device 212 may display the matched string if receiving a command from a user, e.g. via a remote control. Another design is to skip displaying the matched string on a screen. By using this technique, some hidden information may be carried in the subtitle text stream. For example, the matched string is a network address “http://www.xxx.com/productQ” that is added in a subtitle text stream. Under proper configuration, the network address is not displayed even the network address is within the subtitle text stream. Meanwhile, the matched string may be stored for other processing. For example, the response device 212 may connect to the network address and retrieve certain information of product Q, showing the information on a child window of the screen.

Sometimes, there are more than one subtitle text streams received at the same time but only one subtitle text stream is shown on a screen. For example, subtitle text streams of English, Spanish and French are received and only Spanish subtitle text stream is shown. The string matching pattern may be defined in English, which is not appearing on the screen but may still be used for triggering a response action.

The setting and configuration of string matching patterns may be customized by users. For example, an interface may be provided so that a user may define a string matching pattern and associated response.

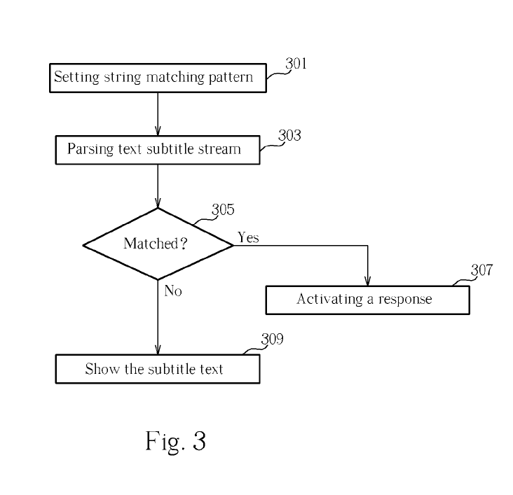

FIG. 3 is a flowchart illustrating an exemplary method of the preferred embodiment. A string matching pattern is set (step 301) by a user or by a manufacturer of a television apparatus. A subtitle text stream is parsed (step 303) for detecting whether there is a matched string that is covered by the string matching pattern in the subtitle text stream (step 305). If there is a matched string found, a response is activated according to the matched string (step 307). If there is no special instruction based on the matched string and/or related setting, the subtitle text stream is displayed (step 309).

The parsing and detection of a matched string may be done during playing a television stream. If the television stream, however, is recorded in advance, e.g. in a DVD or in a hard disk, the parsing and detection of a matched string may also be done before or after playing the television stream. For example, the user may store subtitle text strings in a buffer and search the subtitle text strings for a string matching pattern in advertisement time or after watching a show. The term television stream is not limited to a traditional television broadcasting signals but may also cover any video stream extracted from a local storage device, e.g. a DVD, an optical disc or a hard disk, or a network storage device like an internet streaming or any type of video stream on demand service.

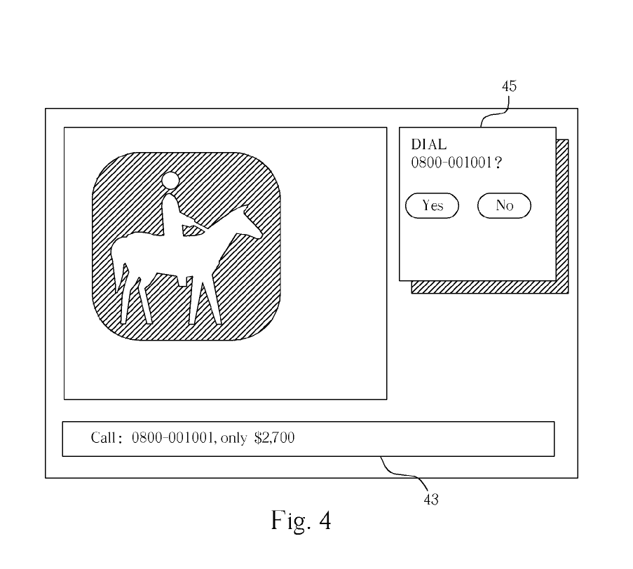

FIG. 4 illustrates an exemplary screen example when a matched string is found. In this example, the string matching pattern is a phone number which appears in a shopping channel. When a phone number in a subtitle area 43 matching a predetermined string matching pattern, a window 45 jumps out for asking whether a call should be made based on the found phone number. Of course, there are many variations that can be designed under the same spirit to meet different requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A television apparatus for playing a television stream, comprising:
a storage for storing a string matching pattern;
a parser for extracting a video stream and a subtitle text stream from the television stream;
a player for playing the video stream; and
a reactor for detecting whether the subtitle text stream contains a matched string covered by the string matching pattern and for activating a response according to the matched string if the matched string exists.

2. The television apparatus of claim 1, wherein the response comprises preparing an e-mail and setting a receiver address of the e-mail based on the matched string if the string matching pattern defines e-mail syntax.

3. The television apparatus of claim 1, wherein the response comprises connecting the television apparatus to a resource object via a network if the string matching pattern defines a network resource locator.

4. The television apparatus of claim 1, wherein the response comprises preparing a phone call and setting the dialing number of the phone call based on the matched string if the string matching pattern defines a phone number.

5. The television apparatus of claim 1, wherein the player keeps displaying the matched string even when subtitle text adjacent to the matched string is no longer displayed by the player.

6. The television apparatus of claim 1, wherein the matched string is highlighted via the player.

7. The television apparatus of claim 1, wherein the matched string is stored for further use by the television apparatus.

8. The television apparatus of claim 7, wherein the stored matched string is displayed under a user command issued to the television apparatus.

9. The television apparatus of claim 1, wherein the player skips displaying the matched string with other subtitle text adjacent to the matched string.

10. The television apparatus of claim 1, wherein the parser detects the text subtitle stream even when the text subtitle stream is not displayed by the player.

11. The television apparatus of claim 1, wherein the string matching pattern is defined by a regular expression.

12. The television apparatus of claim 1, further comprising a configuration interface for a user to set the string matching pattern.

13. The television apparatus of claim 1, further comprising:
an interface for a user to determine the reaction corresponding to the matched string.

14. A method for handling subtitle information of a television apparatus, comprising:
setting a string matching pattern;
parsing a text subtitle stream of a television stream to detect whether there is a matched string covered by the string matching pattern; and
activating a response according to the matched string if the matched string is detected.

15. The method of claim 14, wherein the response is to keep displaying the matched string even when other subtitle text adjacent to the matched string is not displayed.

16. The method of claim 14, wherein the response comprises preparing an e-mail and setting a receiver of the e-mail based on the matched string if the string matching pattern defines an e-mail address.

17. The method of claim 14, wherein the response comprises highlighting the matched string among other subtitle text adjacent to the matched string.

18. The method of claim 14, further comprising:
asking a user command to decide which action to perform based on the matched string.

19. The method of claim 14, further comprising:
providing a configuration interface for a user to set the string matching pattern.

20. The method of claim 14, wherein the text subtitle stream is retrieved from a video stream of the television stream by performing optical character recognition.
